(19) United States
(12) Patent Application Publication
(10) Pub. No.: US 2016/0359540 A1
(43) Pub. Date: Dec. 8, 2016

(54) METHOD AND APPARATUS FOR INTERFERENCE ALIGNMENT IN MULTI-ANTENNA WIRELESS NETWORK HAVING COEXISTED UPLINK AND DOWNLINK

(71) Applicant: ELECTRONICS AND TELECOMMUNICATIONS RESEARCH INSTITUTE, Daejeon (KR)

(72) Inventors: Jin Hyung OH, Sejong (KR); Sang Woon JEON, Andongsi (KR); Chang Ho SUH, Daejeon (KR); Myung Sun SONG, Daejeon (KR)

(73) Assignee: ELECTRONICS AND TELECOMMUNICATIONS RESEARCH INSTITUTE, Daejeon (KR)

(21) Appl. No.: 15/172,449

(22) Filed: Jun. 3, 2016

(30) Foreign Application Priority Data
Jun. 5, 2015 (KR) 10-2015-0079650

(51) Int. Cl. H04B 7/08; H04B 7/04; H04B 7/06

(52) U.S. Cl. CPC H04B 7/0868; H04B 7/0617; H04B 7/0413

(57) ABSTRACT

Provided is a communication method in a wireless communication system using interference alignment. The method includes: transmitting a transmission beam for separated data stream to N₁ (natural number) user terminals by using M₁ (natural number) antennas, by a first AP in a downlink cell; and receiving a reception beam for separated data stream from N₂ (natural number) user terminals by using M₂ (natural number) antennas, by a second AP in an uplink cell, wherein the first AP transmits linear independent transmission beams to improve a degree of freedom while the second AP simultaneously receives orthogonal reception beams, by simultaneously reflecting interference alignment between two cells including downlink and uplink cells.

### CROSS-REFERENCE TO RELATED APPLICATION

This application claims the benefit of priority to Korean Patent Application No. 10-2015-0079650, filed on Jun. 5, 2015 in the Korean Intellectual Property Office, the disclosure of which is incorporated herein in its entirety by reference.

### BACKGROUND OF THE INVENTION

Field of the Invention

The present disclosure relates to a method and an apparatus for an interference alignment in a wireless network such as a wireless LAN, and more particularly, to a method and an apparatus for an interference alignment in a wireless communication system capable of achieving an optimum degree of freedom through an effective interference control in a wireless communication system on a wireless network in which an uplink and a downlink co-exist between an access point (AP) equipped with multi-antenna and user terminals and a wireless communication is accomplished.

Description of the Related Art

As shown in FIG. 1, in a wireless communication system configured of K transmitters (Tx) and K receivers (Tx) in a multi-cell wireless network environment, an interference between channels occurs when each cell of each transmitter (Tx) transmits a message. A research for improving the degree of freedom, and the transmission rate for a multi-cell wireless network has been progressed by analyzing a model for the interference channel.

The degree of freedom of a corresponding K-user interference channel in the K transmitters (Tx) and K receivers (Tx) environment of FIG. 1 may be represented by Equation 1. Here, the SNR is a signal-to-noise ratio, and the Csum (SNR) is a sum of a transmission capacity of total interference channel.

$${lim}_{SNR \to ∞} \frac{{C}_{sum} ( SNR )}{log SNR} \qquad [ Equation 1 ]$$

That is, the degree of freedom of interference channel is a key measure to determine the magnitude of a transmission gain in comparison with a single user in a large SNR area.

As shown in FIG. 1, since the wireless channel has a characteristic of receiving a signal of the transmitter (Tx) by all receivers, with respect to the case of transmitting a message to a specific separated receiver (Rx) by the transmitter (Tx), many experts predicted that the degree of freedom (DoF) of K-user interference channel is 1.

However, beyond the predictions of many experts, the Syed Jafar research group of University of California, Irvine derived a new interference control paradigm called an interference alignment in 2008, and it turned out that the degree of freedom in the K-user interference channel like FIG. 1 is K/2. For example, in a wireless communication system as shown in FIG. 1, four separated data stream may be transmitted by using the interference alignment in the 3-user interference channel (k=3), that is, the degree of freedom 4/3 may be achieved.

Interference alignment that began as a signal space interference alignment based on a beam forming is developed to a technique such as a real interference alignment, an ergodic interference alignment, and the like by many research groups. Further, an improved method for improving the degree of freedom as users are increased is required in consideration of uplink or downlink in a multi-cell or a single-cell wireless network environment.

### SUMMARY OF THE INVENTION

The present disclosure has been made in view of the above problems, and provides a method and an apparatus for an interference alignment in a wireless communication system that forms a communication channel signal beam by performing an uplink access point inter-cell interference alignment (IA), and a downlink inter-cell/intra-cell interference nulling (IN) according to the number of antenna of cells, in order to achieve an optimum degree of freedom through an effective interference control in a wireless communication system on a wireless network such as a wireless LAN in which an uplink and a downlink co-exist between an access point equipped with multi-antenna and user terminals and a wireless communication is accomplished.

In accordance with an aspect of the present disclosure, a communication method in a wireless communication system using interference alignment includes: transmitting a transmission beam for separated data stream to N₁ (natural number) user terminals by using M₁ (natural number) antennas, by a first AP in a downlink cell; and receiving a reception beam for separated data stream from N₂ (natural number) user terminals by using M₂ (natural number) antennas, by a second AP in an uplink cell, wherein the first AP transmits linear independent transmission beams to improve a degree of freedom while the second AP simultaneously receives orthogonal reception beams, by simultaneously reflecting interference alignment between two cells including downlink and uplink cells. An interference nulling for the transmission beams in the downlink is determined according to a comparison result for sizes of the M₁ and the M₂. In a case of M₁≧M₂, an inter-cell interference nulling between the two cells and an intra-cell interference nulling of the transmission beams are applied with respect to the transmission beams. In a case of M₁<M₂, only an intra-cell interference nulling of the transmission beams is applied, excluding an inter-cell interference nulling between the two cells with respect to the transmission beams.

In accordance with another aspect of the present disclosure, a wireless communication system using interference alignment includes: a first AP in a downlink cell configured to transmit a transmission beam for separated data stream to N1 (natural number) user terminals by using M1 (natural number) antennas; and a second AP in an uplink cell configured to receive a reception beam for separated data stream from N2 (natural number) user terminals by using M2 (natural number) antennas, wherein the first AP transmits linear independent transmission beams to improve a degree of freedom while the second AP simultaneously receives orthogonal reception beams, by simultaneously reflecting interference alignment between two cells including downlink and uplink cells. The system further includes: a controller to determine an interference nulling for the transmission beams in the downlink according to a comparison result for sizes of the M₁ and the M₂. In a case of M₁≧M₂, an inter-cell interference nulling between the two cells and an intra-cell interference nulling of the transmission beams are applied with respect to the transmission beams. In a case of M₁<M₂, only an intra-cell interference nulling of the transmission beams is applied, excluding an inter-cell interference nulling between the two cells with respect to the transmission beams.

### BRIEF DESCRIPTION OF THE DRAWINGS

The objects, features and advantages of the present disclosure will be more apparent from the following detailed description in conjunction with the accompanying drawings, in which:

FIG. 1 is a diagram illustrating a K-user interference channel model and a degree of freedom in a conventional wireless communication system;

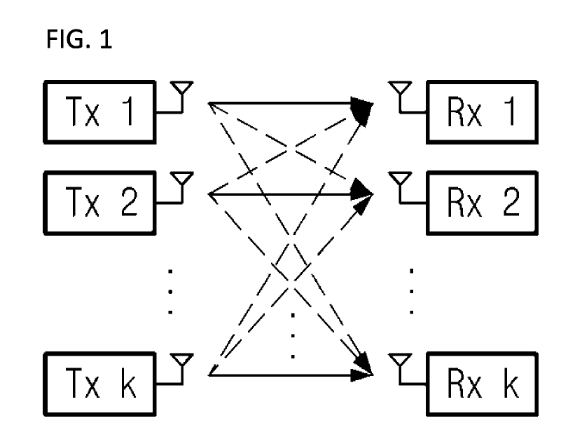

FIG. 2 is a diagram illustrating a wireless communication system configured of an access point equipped with a multi-antenna and user terminals according to an embodiment of the present disclosure;

FIG. 3 is a diagram illustrating an interference alignment operation in a wireless communication system according to an embodiment of the present disclosure;

FIG. 4 is a flowchart illustrating a beam vector setting method according to an interference alignment operation in a wireless communication system according to an embodiment of the present disclosure;

FIG. 5 is a diagram illustrating a relationship of data stream in an uplink/downlink to be referred to the interference alignment operation of FIG. 4;

FIG. 6 is a diagram illustrating a relationship between optimum degree of freedom of the present disclosure in comparison with a conventional method; and

FIG. 7 is a diagram illustrating a graph of a value of the degree of freedom when N=6 in Equation 15.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

First, the notation defined as described below is used for a description of the present disclosure. That is, [1:n] means {1, 2, . . . , n}. For the real number r, r⁺ means max (r, 0). For the set {aᵢ} of a vector aᵢ (i is given from 1 to a certain natural number), the span {aᵢ} means a signal space configured of corresponding vectors. For the matrix A, A^{T} means Transpose and A^{H} means Conjugate Transpose. In addition, for the set {Ai} of a matrix Ai (i is given from 1 to a certain natural number) configured of a vector or a scalar element, the diag{Ai} means a block square matrix implemented of corresponding matrices. The 0 n means n×1 all-zero vector.

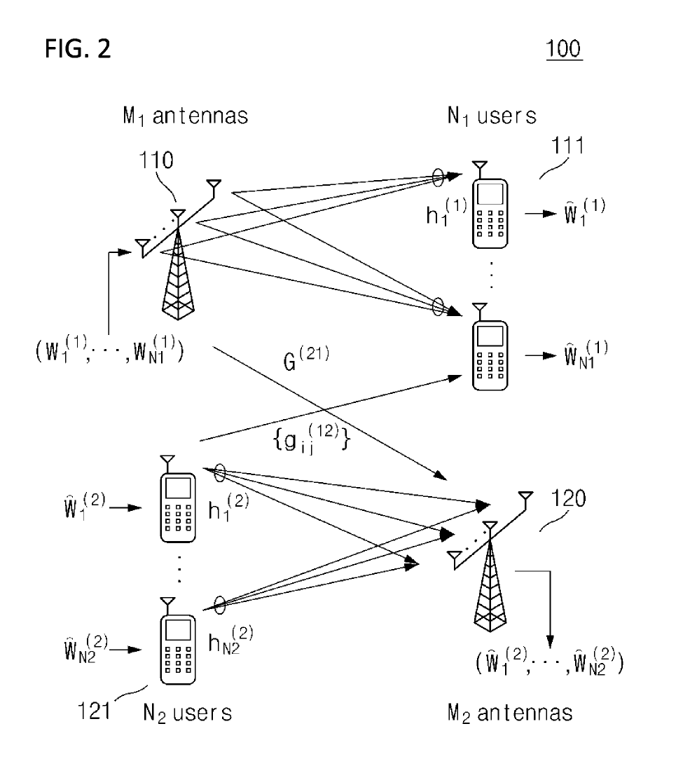

FIG. 2 is a diagram illustrating a wireless communication system 100 configured of an access point (AP) 110 and 120 equipped with a multi-antenna and user terminals 111 and 121 according to an embodiment of the present disclosure. FIG. 2 illustrates a wireless communication system 100 on a wireless network such as a wireless LAN in a co-existed uplink and downlink environment.

In FIG. 2, a first AP 110 which has M₁ (natural number) antennas and which operates as downlink transmits separated N₁ (natural number) messages (W₁⁽¹⁾, W₂⁽¹⁾, . . . , W_{N1}⁽¹⁾) to N₁ user terminals 111, and a second AP 120 which has M₂ (natural number) antennas and which operates as uplink receives separated N₂ messages (W₁⁽²⁾, W₂⁽²⁾, . . . , W_{N2}⁽²⁾) from N₂ (natural number) user terminals 121.

In the present disclosure, it is assumed that the user terminal has a single antenna and is connected to AP to transmit and receive a message. A transmission and reception message (communication signal) between the user terminal and the AP may be a signal for a wireless mobile communication according to a protocol such as WCDMA, LTE, etc. In addition, in some cases, it may be a signal for a wireless short range communication such as WiFi, Bluetooth, Zigbee, etc. and may be extended and applied to a signal for other wireless communication. In addition, the access point (AP) 110 and 120 may be a router to send and receive the above communication signal to/from the user terminal or may be a small-cell base station such as a femtocell/picocell, and, in some cases, may be a macro base station or its repeater.

Assuming that each AP and the user terminal previously obtain and recognize channel information of transmission and reception message, at time t, a signal which the user terminal 111 receives from a first AP 110 is represented in Equation 2 respectively with respect to iε[1:N₁], and a signal which a second AP 120 receives from the user terminal 121 is represented in Equation 3 respectively with respect to jε[1:N₂].

$$\begin{matrix}{y}_{i}^{( 1 )} [ t ] = {h}_{i}^{( 1 )} [ t ] {x}^{( 1 )} [ t ] + {\sum }_{j = 1}^{{N}_{2}} {g}_{ij}^{( 12 )} [ t ] {x}_{j}^{( 2 )} [ t ] + {z}_{i}^{( 1 )} [ t ] & [ Equation 2 ] \\ {y}^{( 2 )} [ t ] = {\sum }_{j = 1}^{{N}_{2}} {h}_{j}^{( 2 )} [ t ] {x}_{j}^{( 2 )} [ t ] + {G}^{( 21 )} [ t ] {x}^{( 1 )} [ t ] + {z}^{( 2 )} [ t ] & [ Equation 3 ]\end{matrix}$$

Here, hᵢ⁽¹⁾[t] is the AP 1 (110) is a 1×M₁ channel (signal) vector of a channel signal which the first AP 110 transmits, x⁽¹⁾[t]=(x₁ x₂ . . . x_{N1})^{T} is a separated transmission signal vector corresponding to N₁ messages (W₁⁽¹⁾, W₂⁽¹⁾, . . . , W_{N1}⁽¹⁾, xⱼ⁽²⁾[t] is a transmission signal of j-th user terminal 121 in the second AP 120 cell, and zᵢ⁽¹⁾[t] is a gaussian white noise vector in i-th user terminal 111. gᵢⱼ⁽¹²⁾[t] is a scalar channel (signal) which reaches the user terminal 111 according to the channel interference of the APs, hⱼ⁽²⁾[t] is a M₂×1 channel (signal) vector, G⁽²¹⁾[t] is given by a M₂×M₁ channel matrix which reaches the second AP 120 according to the channel interference of the APs. x⁽²⁾[t]=(X₁ x₂ . . . X_{N2})^{T} is a separated transmission signal vector corresponding to N₂ messages (W₁⁽¹⁾, W₂⁽¹⁾, . . . , W_{N2}⁽¹⁾, and z⁽²⁾[t] is a gaussian white noise vector in the second AP 120. Each AP and the user should satisfy the transmission power P. Here, a time-varying channel is assumed and it is assumed that each channel component complies with an arbitrary continuous probability distribution.

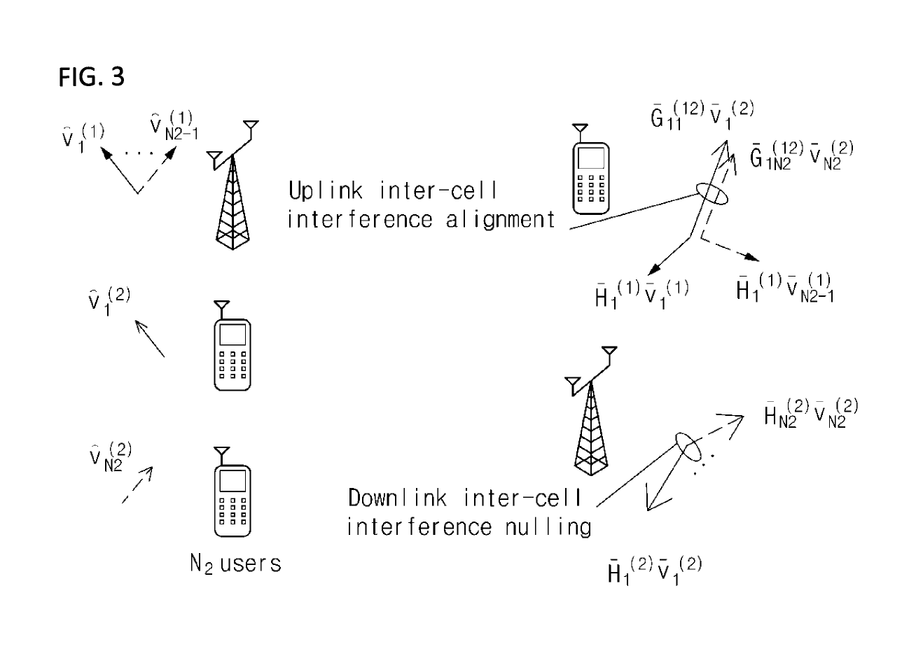

FIG. 3 is a diagram illustrating an interference alignment operation in a wireless communication system 100 according to an embodiment of the present disclosure. FIG. 3 shows an environment of M₁=2, N₁=M₂=1 for the exemplary description for the interference alignment operation in a wireless communication system 100 according to an embodiment of the present disclosure. Here, the first AP 110 transmits N₂−1 data stream by forming a transmission beam through a 2N₂×1 beam vector {v̅ᵢ⁽¹⁾}_{iε[1:N}_{₂}_{-1]}, and the user terminal 121 of the second AP 120 cell transmits data stream respectively by forming a transmission beam through a N₂×1 beam vector v̅ⱼ⁽²⁾ (jε[1:N₂]). That is, after each user terminal 121 of the second AP 120 cell forms a transmission beam by using the symbol time N₂ times, the first AP 110 may transmit corresponding stream through the formed transmission beam.

Here, the channels formed during N2 symbol time diag(hᵢ⁽¹⁾[1], . . . , hᵢ⁽¹⁾[N₂]), diag(hⱼ⁽²⁾[1], . . . , hⱼ⁽²⁾[N₂]), diag(G⁽²¹⁾[1], . . . , G⁽²¹⁾[N₂]), diag(gᵢⱼ⁽¹²⁾[1], . . . , gᵢⱼ⁽¹²⁾[N₂]) are denoted as H̅ᵢ⁽¹⁾, H̅ⱼ⁽²⁾, G̅⁽²¹⁾, G̅ᵢⱼ⁽¹²⁾, respectively.

A linear independence {v̅ᵢ⁽¹⁾}_{iε[1:N}_{₂}_{-1]} may be set to satisfy the inter-cell interference nulling condition between the first AP 110 cell and the second AP 120, that is, G̅⁽²¹⁾v̅ᵢ⁽¹⁾=0_{N}_{₂} in all iε[1:N₂−1]. In addition, a linear independence {v̅ⱼ⁽²⁾}_{jε[1:N}_{_{2]}} may be set so that the inter-cell interference alignment condition, that is, G̅ᵢⱼ⁽¹²⁾v̅ⱼ⁽²⁾ may be the same for all jε[1: N₂]. Therefore, in this inter-cell interference nulling (IN) and inter-cell interference alignment (IA) condition, as shown in FIG. 3, since 2N₂−1 stream is transmitted during N₂ symbol time, the degree of freedom which can be achieved through this may be given as (2N₂−1)/N₂.

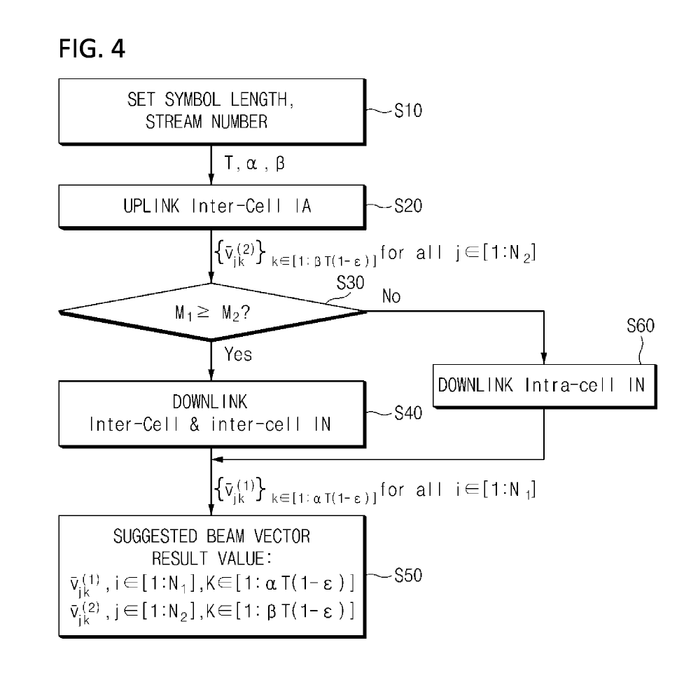

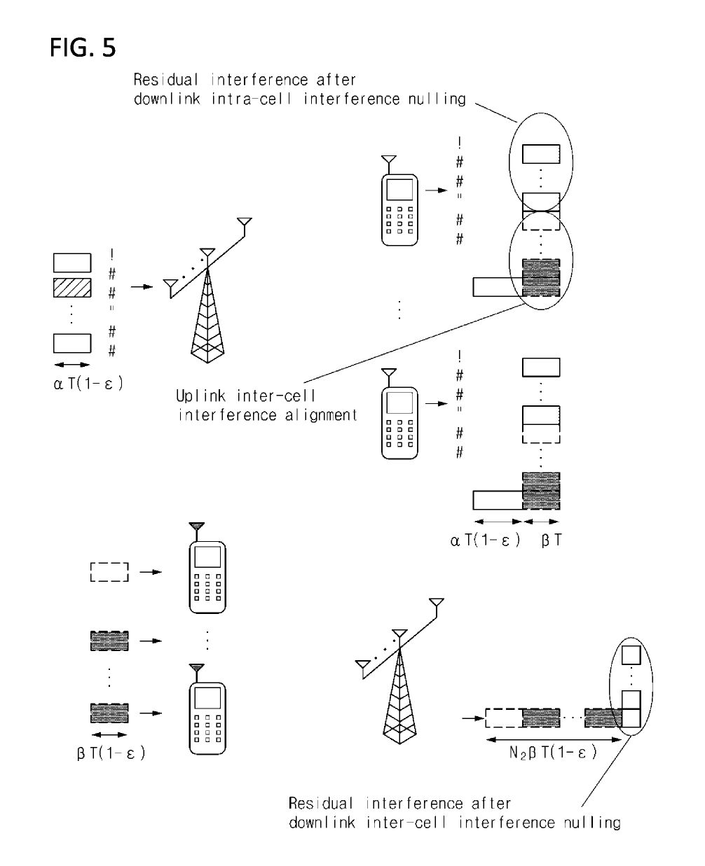

FIG. 4 is a flowchart illustrating a beam vector setting method according to an interference alignment operation in a wireless communication system 100 according to an embodiment of the present disclosure, and FIG. 5 is a diagram illustrating a relationship of data stream in an uplink/downlink to be referred to the interference alignment operation of FIG. 4. For example, the following beam vector setting method according to an interference alignment operation may be performed as a controller provided in each AP or an external controller which generally controls the APs transmits and receives necessary information to obtain.

<First Interference Alignment Technique: Uplink Inter-Cell IA, Downlink Inter-Cell IN and Intra-Cell IN>

First, it is assumed that the transmitter of each AP 110, 121 forms a transmission beam vector during a preset symbol time T and transmits a corresponding data stream through the formed transmission beam vector (S10). Here, the parameter a, 13, ε is previously set depending on a system environment, and 0≦α, β≦1. In FIG. 5, it is assumed that α≧β, for convenience. The channel diag(hᵢ⁽¹⁾[1], . . . , hᵢ⁽¹⁾[T]), diag(hⱼ⁽²⁾[1], . . . , hⱼ⁽²⁾[T]), diag(G⁽²¹⁾[1], . . . , G⁽²¹⁾[T]), diag(gᵢⱼ⁽¹²⁾[1], . . . , gᵢⱼ⁽¹²⁾[T]) formed during the symbol time T are denoted as H̅ᵢ⁽¹⁾, H̅ⱼ⁽²⁾, G̅⁽²¹⁾, G̅ᵢⱼ⁽¹²⁾ respectively. As shown in FIG. 2, iε[1:N₁], jε[1:N₂].

In the second AP 120 cell, according to the signal space interference alignment in the uplink, for all jε[1:N₂], j-th user terminal 121 transmits βT(1−ε) separated data stream to the second AP 120 through the beam vector {v̅ⱼₖ⁽²⁾}_{kε[1:βT(1-ε)]} (S20). At this time, with respect to the beams which the second AP 120 receives, a linear independence {v̅ⱼₖ⁽²⁾}_{kε[1:βT(1-ε)]} may be set to occupy a maximum βT signal space as shown in Equation 4 for all jε[1:N₂], and, at the same time, c→0 can be satisfied when T→∞.

span({G̅ᵢⱼ⁽¹²⁾v̅ⱼₖ⁽²⁾}_{iε[1:N}_{₁}_{],jε[1:N}_{₂}_{],kε[1:βT(1-ε)]}) [Equation 4]

While considering the signal space interference alignment in the uplink, in the case of M₁≧M₂, the first AP 110 determines the downlink inter-cell and intra-cell IN (S40), and, with respect to all iε[1:N₁], transmits the transmission beams of αT(1-ε) separated data stream to i-th user terminal 111 of the first AP 110 cell through the beam vector {v̅ᵢₖ⁽¹⁾}_{kε[1:αT(1-ε)]} (S50).

At this time, for the inter-cell interference nulling, with respect to the transmission beams in the first AP 110, the condition of Equation 5 should satisfy all of iε[1:N₁], jε[1:N₂], kε[1:αT(1-ε], 1ε[1:βT(1-ε)],

(H̅ⱼ⁽²⁾v̅ⱼₗ⁽²⁾)^{H}G̅⁽²¹⁾v̅ᵢₖ⁽¹⁾₌₀ [Equation 5]

Further, for the intra-cell interference nulling, the condition of Equation 6 should satisfy all of i, jε[1:N₁], i≠j, k, lε[1:αT(1-ε)].

(H̅ⱼ⁽¹⁾v̅ⱼₗ⁽¹⁾)^{H}H̅ⱼ⁽¹⁾v̅ᵢₖ⁽¹⁾=0 [Equation 6]

Therefore, according to Equation 5 and Equation 6, v̅ᵢₖ⁽¹⁾ is made of beams (e.g., polarized signal) formed to be orthogonal to each other with respect to every vector of Equation 7.

{v̅ⱼₗ^{(2)H}H̅ⱼ^{(2)H}G̅⁽²¹⁾}_{jε[1:N}_{₂}_{],lε[1:βT(1-ε)]}

{v̅ⱼₗ^{(1)H}H̅ⱼ^{(1)H}H̅ⱼ⁽¹⁾}_{jε[1:N}_{₁}_{],j≠i,lε[1:αT(1-ε)]} [Equation 7]

Since Equation 7 is made of (N₂β+(N₂−1)α)T(1−ε) vectors, and v̅ᵢₖ⁽¹⁾ made of M₁T components, in the case of satisfying the condition of Equation 8, the linear independence {v̅ᵢₖ⁽¹⁾}_{kε[1:αT(1-ε)]} can be set for all iε[1:N₁].

M₁T−(N₂β+(N₁−1)α)T(1−ε)>αT(1−ε)

<Second Interference Alignment Technique: Uplink Inter-Cell IA, and Downlink Intra-Cell IN>

Second, at step S30, when it is not M₁≧M₂ (M₁<M₂), the first AP 110 determines only the downlink intra-cell IN (S60), and, with respect to all iε[1:N₁], transmits αT(1−ε) separated data stream to i-th user terminal 111 of the first AP 110 through the beam vector {v̅ᵢₖ⁽¹⁾}_{kε[1:αT(1-ε)]} (S50). That is, a downlink beam forming vector is configured to satisfy only Equation 5.

Thus, in the case of satisfying the condition of Equation 9 instead of the condition of Equation 8, the linear independence {v̅ᵢₖ⁽¹⁾}_{kε[1:αT(1-ε)]} can be set for all iε[1:N₁].

M₁T−(N₁−1)αT(1−ε)>αT(1−ε) [Equation 9]

An achievable degree of freedom in the above wireless network having coexisted uplink and downlink is described.

First, in the above <first interference alignment technique>, in FIG. 5, Equation 10 should be satisfied so that each user terminal 111 in the first AP 110 may receive a corresponding data stream.

αT(1−ε)+βT≦T [Equation 10]

In addition, in the same way, Equation 11 should be satisfied so that the second AP 120 may receive a corresponding data stream from each user terminal 121 within the cell.

N₂βT(1−ε)≦M₂T [Equation 11]

Finally, Equation 8 should be satisfied for interference nulling (IN).

Thus, since ε→0 when T→∞, the degree of freedom like Equation 12 may be achieved through the <first interference alignment technique> by using Equation 8, Equation 10, Equation 11

$${d}_{Σ} = {max}_{{α + β \leq 1}_{{{N}_{2} β \leq {M}_{2}}_{{N}_{1} α + {N}_{2} β \leq {M}_{1}}}} \{ {N}_{1} α + {N}_{2} β \} \qquad [ Equation 12 ]$$

When interpreting in the same way, the degree of freedom like Equation 13 may be achieved through the <second interference alignment technique>.

$${d}_{Σ} = {max}_{{α + β \leq 1}_{{{N}_{1} α + {N}_{2} β \leq {M}_{2}}_{{N}_{1} α \leq {M}_{1}}}} \{ {N}_{1} α + {N}_{2} β \} \qquad [ Equation 13 ]$$

Finally, assuming that the maximum value of the degree of freedom of Equation 12 is d_{Σ,1}, and the maximum value of the degree of freedom of Equation 13 is d_{Σ,2}, the optimum degree of freedom in the wireless communication system 100 of FIG. 2 may be calculated as Equation 14.

$${d}_{Σ} = max ( {d}_{Σ , 1} {d}_{Σ , 2} ) = min \{ \frac{\begin{matrix}{N}_{1} {N}_{2} + min ( {M}_{1} , {N}_{1} ) {( {N}_{1} - {N}_{2} )}^{+} + \\ min ( {M}_{2} , {N}_{2} ) {( {N}_{3} - {N}_{1} )}^{+}\end{matrix}}{max ( {N}_{1} , {N}_{2} )} , {M}_{1} + {N}_{2} , {N}_{1} + {M}_{2} , max ( {M}_{1} , {M}_{2} ) , max ( {N}_{1} , {N}_{2} ) \} \qquad [ Equation 14 ]$$

As described above, the technical excellence of the present disclosure enables to (1) apply the interference alignment method according to the number of different antennas between APs 110 and 120 or the number of different user terminals within each cell, (2) provide the degree of freedom significantly improved in comparison with the existing up-link or downlink operation, and (3) operate as an efficient interference control technique when uplink/downlink co-exist as it is impossible to synchronize the uplink or the downlink.

Further, the performance excellence of the present disclosure enables to (1) provide a significantly higher degree of freedom and transmission rate in comparison with the conventional technique to which the interference alignment is not applied, (2) obtain the optimum degree of freedom in any antenna number or user number in a dual-cell environment, and (3) be implemented by only a linear signal processing by the interference alignment technique based on a signal space so that it is easy to implement in comparison with the interference alignment based on a non-linear signal processing.

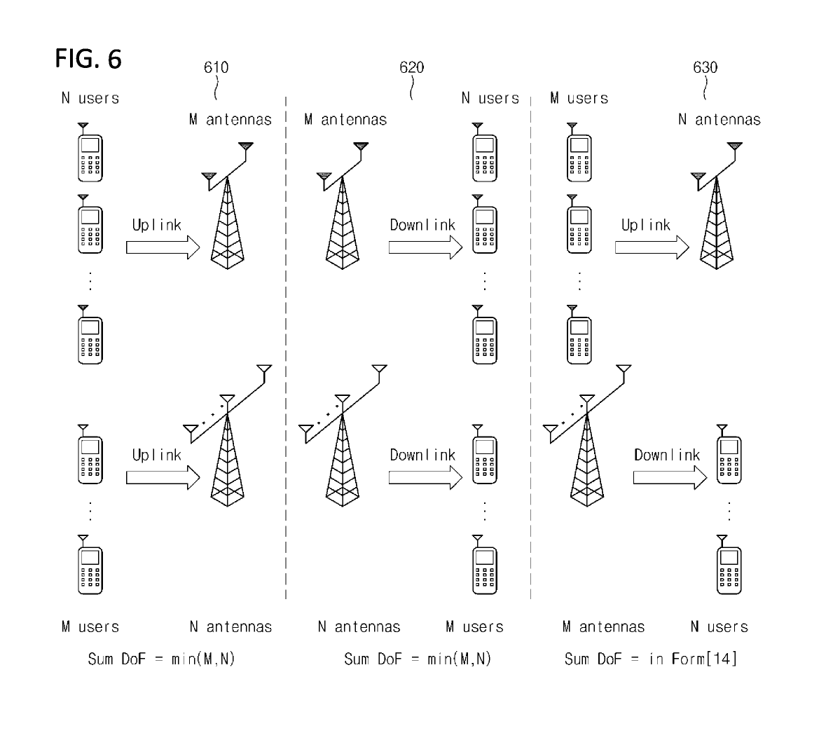

In particular, with regard to the performance excellence, in the case of the suggested technique, the degree of freedom in a wireless network such as a wireless LAN can be greatly improved in comparison with the case of operating only in the uplink or downlink in the related art. For example, an environment in which M₁=N₂=M, M₂=N₁=N is considered. When both of two cells operate only in the up-link or the down-link as in the conventional method, the degree of freedom is given as min(M, N) such that there is no gain compared to a single cell (see 610, 620 in FIG. 6). However, when the suggested technique is applied after one cell is set to the uplink and the other cell is set to the down-link, the optimal degree of freedom of Equation 15 can be achieved from Equation 14 (see 630 in FIG. 6).

$${d}_{Σ} = \{ \begin{matrix}\frac{M ( 2 N - M )}{N} if M \leq N \\ \frac{N ( 2 M - N )}{M} if M \geq N\end{matrix} \qquad [ Equation 15 ]$$

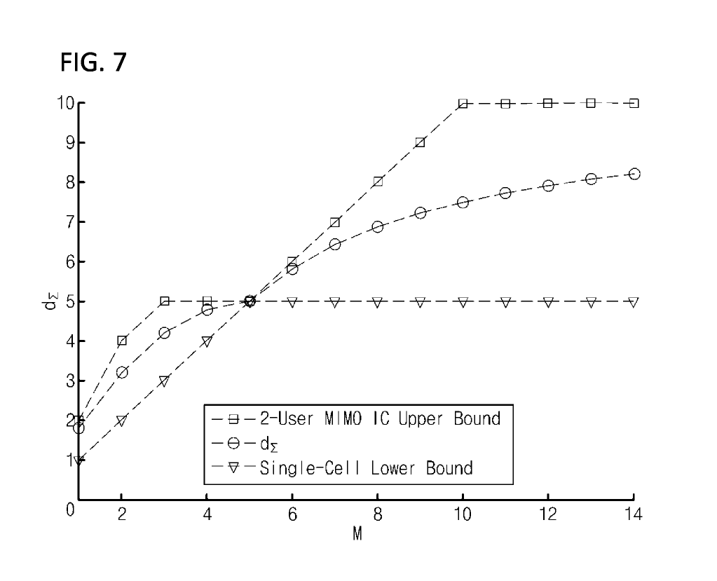

FIG. 7 is a diagram illustrating a graph of a value of the degree of freedom when N=6 in Equation 15. As shown in FIG. 7, it can be seen that the degree of freedom dΣ of Equation 15 is more greater degree of freedom in comparison with the degree of freedom value (single-cell lower bound) of the conventional technique obtained when both two cells operate only in the uplink or the downlink, within the degree of freedom value (2-User MIMO IC upper bound) in the case of permitting a complete cooperation between users within each cell. In an area in which M is sufficiently large, it can be seen that a gain which is greater two times compared to the conventional technique is generated, and this technique of the present disclosure provides the degree of freedom which is improved 30% or more than the conventional technique in a common antenna environment (e.g., M=8, etc.).

According to the method and the apparatus for interference alignment in a wireless communication system according to the present disclosure, the method can form a beam of a communication channel signal to achieve an optimum degree of freedom when a specific access point cell in a wireless communication system on a wireless network such as a wireless LAN operates in the up-link and the remaining cell operates in the downlink. That is, the conventional method focuses on an environment in which all cells operate in the uplink or the downlink, but does not adopt at all the interference alignment technique in the uplink/downlink coexistence environment as in the present disclosure. The interference alignment technique of the present disclosure can achieve the optimal degree of freedom in the uplink/downlink coexistence environment.

Further, an operation area can be determined to maximize the degree of freedom of the uplink, the downlink, or between co-existed uplink/downlink, for example, the network is set to an uplink/downlink coexistence environment in a specific operation area according to the antenna and the user environment.

In addition, the communications environment can be improved according to the interference technique of the present disclosure together with the reverse Time Division Duplex (TDD), the dynamic duplex, and the like in the uplink/downlink coexistence environment, due to the inter-cell synchronization difficulty, the load balancing, the dynamic resource allocation, and the like.

In addition, the technical excellence of the present disclosure enables to (1) apply the interference alignment method according to the number of different antennas between APs or the number of different user terminals within each cell, (2) provide the degree of freedom significantly improved in comparison with the existing up-link or downlink operation, and (3) operate as an efficient interference control technique when uplink/downlink co-exist as it is impossible to synchronize the uplink or the downlink.

Further, the performance excellence of the present disclosure enables to (1) provide a significantly higher degree of freedom and transmission rate in comparison with the conventional technique to which the interference alignment is not applied, (2) obtain the optimum degree of freedom in any antenna number or user number in a dual-cell environment, and (3) be implemented by only a linear signal processing by the interference alignment technique based on a signal space so that it is easy to implement in comparison with the interference alignment based on a non-linear signal processing.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A communication method in a wireless communication system using interference alignment, the method comprising:
transmitting a transmission beam for separated data stream to N₁ (natural number) user terminals by using M₁ (natural number) antennas, by a first AP in a downlink cell; and
receiving a reception beam for separated data stream from N₂ (natural number) user terminals by using M₂ (natural number) antennas, by a second AP in an uplink cell,
wherein the first AP transmits linear independent transmission beams to improve a degree of freedom while the second AP simultaneously receives orthogonal reception beams, by simultaneously reflecting interference alignment between two cells including downlink and uplink cells.

2. The method of claim 1, wherein an interference nulling for the transmission beams in the downlink is determined according to a comparison result for sizes of the M₁ and the M₂.

3. The method of claim 1, wherein an inter-cell interference nulling between the two cells and an intra-cell interference nulling of the transmission beams are applied with respect to the transmission beams, in a case of M₁≧M₂.

4. The method of claim 1, wherein only an intra-cell interference nulling of the transmission beams is applied, excluding an inter-cell interference nulling between the two cells with respect to the transmission beams, in a case of M₁<M₂.

5. A wireless communication system using interference alignment, the system comprising:
a first AP in a downlink cell configured to transmit a transmission beam for separated data stream to N1 (natural number) user terminals by using M1 (natural number) antennas; and
a second AP in an uplink cell configured to receive a reception beam for separated data stream from N2 (natural number) user terminals by using M2 (natural number) antennas,
wherein the first AP transmits linear independent transmission beams to improve a degree of freedom while the second AP simultaneously receives orthogonal reception beams, by simultaneously reflecting interference alignment between two cells including downlink and uplink cells.

6. The system of claim 5, further comprising a controller to determine an interference nulling for the transmission beams in the downlink according to a comparison result for sizes of the M₁ and the M₂.

7. The system of claim 5, wherein an inter-cell interference nulling between the two cells and an intra-cell interference nulling of the transmission beams are applied with respect to the transmission beams, in a case of M₁≧M₂.

8. The system of claim 5, wherein only an intra-cell interference nulling of the transmission beams is applied, excluding an inter-cell interference nulling between the two cells with respect to the transmission beams, in a case of M₁<M₂.
